(19) United States
(12) Patent Application Publication
(10) Pub. No.: US 2025/0186937 A1
(43) Pub. Date: Jun. 12, 2025

(54) ACID GAS REMOVAL WATER BALANCE INTELLIGENT CONTROL

(71) Applicant: SAUDI ARABIAN OIL COMPANY, Dhahran (SA)

(72) Inventors: Dedik Rahmat Ermawan, Jubail (SA); Humoud M. Harbi, Jubail (SA)

(73) Assignee: SAUDI ARABIAN OIL COMPANY, Dhahran (SA)

(21) Appl. No.: 18/531,156

(22) Filed: Dec. 6, 2023

(51) Int. Cl. B01D 53/14

(52) U.S. Cl. CPC B01D 53/1456; B01D 53/1412

(57) ABSTRACT

A process for acid gas removal includes feeding a sour natural gas to a contactor, feeding a lean amine adsorbent to the contactor, contacting the sour natural gas with the lean amine adsorbent to produce a sweet natural gas and a rich amine absorbent, recovering the sweet natural gas as an overheads from the contactor, recovering the rich amine absorbent as a bottoms from the contactor, feeding the rich amine absorbent to a regenerator, recovering desorbed acid gases as a regenerator overheads, producing the lean amine adsorbent recovered as a regenerator bottoms, and maintaining an amount of water circulating. A system for carrying out acid gas removal includes a contactor, a regenerator, a regenerator overhead temperature sensor, a feed gas flow rate sensor, and a make-up water feed system.

### FIELD OF THE DISCLOSURE

Embodiments of the present disclosure generally relate to systems and processes for controlling the water content in aqueous absorbents used in acid gas removal units.

### BACKGROUND

During sweetening of natural gas via acid gas removal (AGR) with an aqueous solvent, the AGR system undergoes water losses due to water entrainment and evaporative losses. Managing AGR water balance is crucial for maintaining steady and reliable Gas Treating (GT) operations. Any upset in system water balance will impact amine strength and is estimated to lead to significant costs.

### SUMMARY OF THE CLAIMED EMBODIMENTS

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a process for acid gas removal which includes feeding a sour natural gas to a contactor, feeding a lean amine adsorbent to the contactor, contacting the sour natural gas with the lean amine adsorbent to produce a sweet natural gas and a rich amine absorbent, recovering the sweet natural gas as an overheads from the contactor, recovering the rich amine absorbent as a bottoms from the contactor, feeding the rich amine absorbent to a regenerator, recovering desorbed acid gases as a regenerator overheads, producing the lean amine adsorbent recovered as a regenerator bottoms, and maintaining an amount of water circulating.

In another aspect, embodiments disclosed herein relate to a system for carrying out acid gas removal, which includes a contactor, a sour natural gas feed line, a lean amine adsorbent feed line, a contactor overheads recovery line, a contactor bottoms recovery line, a regenerator, a regenerator overheads recovery line, a regenerator bottoms recovery line, a regenerator overhead temperature sensor, a feed gas flow rate sensor, and a make-up water feed system.

Other aspects and advantages will be apparent from the following description and the appended claims.

### BRIEF DESCRIPTION OF DRAWINGS

FIG. 1 is a simplified process flow diagram of a system to automatically control a make-up water flow rate in an acid gas removal gas treatment system in accordance with one or more embodiments of the present disclosure.

FIG. 2 is a plot of the relationship between acid gas temperature and make-up water flow rate for a plurality of train capacity values in accordance with one or more embodiments of the present disclosure.

### DETAILED DESCRIPTION

Embodiments herein relate to improving the operation of acid gas removal (AGR) systems by intelligently controlling the water content in the circulating absorbent. Embodiments herein are directed toward the sweetening of sour natural gas using AGR systems having improved water balance control. AGR systems herein having an improved water balance control may also be used to recover acid gases from various streams within a refinery, such as a light hydrocarbon or hydrogen stream containing hydrogen sulfide, such as may be produced during hydrodesulfurization processes.

AGR systems include a contactor and a regenerator. In the contactor, a feed gas, such as a sour natural gas, containing acid gases, such as carbon dioxide and hydrogen sulfide, and hydrocarbons, such as methane or a mixture of methane and ethane, is contacted in countercurrent flow with a lean aqueous absorbent, comprising water and a solvent. The acid gases are absorbed in the aqueous absorbent, producing a sweetened hydrocarbon, recovered as an overhead vapor product from the contactor, and a rich aqueous absorbent, containing the aqueous absorbent comprising water, solvent, and absorbed acid gases, recovered as a bottoms liquid product from the contactor.

The rich aqueous absorbent is then fed to the regenerator to recover the acid gases and regenerate the aqueous absorbent for continued use in the contactor. In the regenerator, the rich aqueous absorbent is heated and distilled to desorb the acid gases from the aqueous absorbent, recovering an overhead vapor product comprising the acid gases and a bottoms liquid product comprising the lean aqueous absorbent.

Aqueous absorbents useful in embodiments herein may include chemical absorbents, such as amines, and physical absorbents, such as glycols or alcohols. Amine absorbents useful in embodiments herein may include, for example monoethanolamine (MEA), diglycolamine (DGA), diethanolamine (DEA), diisopropanolamine (DPA), and methyldiethanolamine (MDEA), among others. Physical absorbents useful in embodiments herein may include, for example, methanol, dimethyl ether of polyethylene glycol (DEPG), N-methyl pyrrolidone, and propylene carbonate, among others.

In particular embodiments, the aqueous absorbent is an aqueous amine absorbent, comprising water and an amine absorbent. The concentration ranges of the solvent in the aqueous solutions that are used may vary based upon the particular solvent that is used. For example, the concentration of MEA may be in a range of from 10 to 20 wt % of the total aqueous solution, while a concentration of DEA may be in a range of from 25 to 35 wt % of the total aqueous solution.

The process for AGR from a sour natural gas, as briefly described above, includes feeding a sour natural gas to a contactor, where the sour natural gas includes methane and one or more acid gases selected from carbon dioxide and hydrogen sulfide. A lean amine absorbent is conveyed to the contactor and contacted in countercurrent flow with the sour natural gas, producing a sweet natural gas, comprising methane and entrained water, and a rich amine absorbent, comprising water, solvent, and absorbed acid gases. The sweet natural gas is recovered as an overheads vapor product from the contactor. The rich amine adsorbent is recovered as a bottoms liquid product from the contactor. The rich amine absorbent is then fed to a regenerator, and through the application of heat and/or decreased pressure, acid gases are desorbed from the solvent. The regenerator recovers desorbed acid gases in a regenerator overheads vapor stream, and produces the lean amine adsorbent, recovered as a regenerator liquid bottoms stream. The regenerator overheads includes water evaporate and desorbed acid gases.

As outlined above, water may be lost to both the sweetened hydrocarbon stream recovered from the contactor and the acid gas recovered from the regenerator. Although make-up water may be added periodically or continuously, fluctuations in solvent composition impact separation efficiency.

It has been found that water entrainment losses and evaporative losses may be directly correlated to train capacity (feed gas flow rate) and regenerator overhead temperature respectively. Embodiments herein are directed toward improving the water balance in AGR operations through automatic control over the make-up water flow rate using feed gas flow rate and regenerator overhead temperature measurements. Improving AGR water balance, maintaining the concentration of water and absorbent circulating in the AGR system, will lead to improved performance and reduced costs.

Processes herein maintain an amount of water circulating in the AGR process. Maintaining the amount of water circulating in the AGR process includes measuring the flow rate of the sour natural gas, measuring the temperature of the regenerator overheads, and adjusting the flow rate of make-up water based on the measured flow rate of the sour natural gas and the measured temperature of the regenerator overheads.

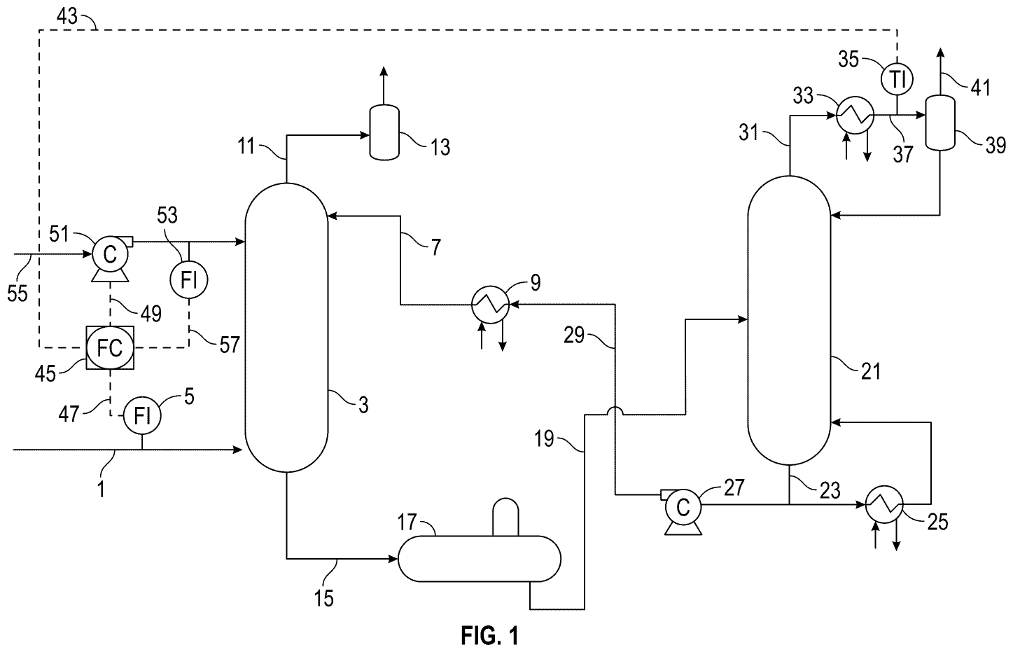

Referring now to FIG. 1, a simplified process flow diagram of systems for acid gas removal and maintaining water balance according to embodiments herein is illustrated. This diagram is exemplary and is meant to illustrate the typical components of an AGR system to which automatic AGR control is applicable. AGR systems may include other components or omit some components and still be applicable to AGR automatic water balance control.

Sour gas is fed through line 1 into a contactor 3. A flow indicator 5 acts as a feed gas flow rate sensor and allows for monitoring the sour gas flow rate into the contactor 3. The feed gas flow rate affects the amount of entrainment water losses, and monitoring the feed gas flow rate is used in embodiments herein to calculate the water entrainment losses. A lean amine adsorbent is fed into the contactor 3 through line 7, wherein the lean amine adsorbent comprises water and a solvent.

The sour natural gas is contacted with the lean amine adsorbent in the contactor 3 to produce a sweet natural gas, comprising methane and entrained water, and a rich amine absorbent, comprising water, solvent, and absorbed acid gases.

The sweet natural gas is collected as an overheads from the contactor 3 through recovery line 11. The contactor 3 may include an overhead system including a knock-out drum 13, among other equipment, to reduce the amount of entrained water droplets contained in the overhead vapors. The rich amine adsorbent is recovered as a bottoms from the contactor 3 through recovery line 15. The rich amine adsorbent is then fed through lines 15/19 into regenerator 21. In some embodiments, such as illustrated, a flash drum 17 may be disposed intermediate contactor 3 and regenerator 21. The regenerator removes acid gases and regenerates the lean amine adsorbent. Lean amine adsorbent is collected as a bottoms from the regenerator 21 through line 23 and passes into reboiler 25 or amine pump 27 after regeneration. Regenerated lean amine adsorbent is fed from amine pump 27 into line 29 to pass into amine cooler 9 and thence to contactor 3. Desorbed acid gases are collected as a regenerator overheads, which also contains entrained or evaporated water. The regenerator overheads pass from line 31 into an overheads condensation system, including cooler 33 and a condensate (knock-out) drum 39. A temperature indicator 35 is provided on line 37, the cooled overhead stream exiting cooler 33 and passing to knock-out drum 39. The regenerator overheads temperature sensor monitors the regenerator overheads temperature. The regenerator overheads pass from cooler 33 into line 37 and into knock-out drum 39 where acid gas leaves the system through line 41.

Make-up water is added to the system via flow line 55. Make-up water flow into the regenerator is provided by a variable speed pump 51. In other embodiments, the make-up water flow may be provided by a pump and an associated flow control valve. As illustrated in FIG. 1, the make up water flow may be provided to contactor 3. In other embodiments, make-up water flow may be provided to flash drum 17, regenerator 21, or overheads or reboil systems associated with contactor 3 or regenerator 21.

The system also includes a processor 45 configured to control the flow of make up water to the system. The processor may be a local controller or a digital control system associated with the overall plant. The processor 45 is configured to control the flow of make up water provided to the system to maintain a target water concentration, or a water-solvent ratio, within the circulating aqueous absorbent. Processor 45 is configured to calculate water losses based on the flow rate of feed gas 5 and the temperature of overhead stream 37.

Temperature indicator 35 communicates a measured temperature through communication line 43 to processor 45. The flow indicator 5 communicates a measured flow rate of the feed gas through communication line 47 to processor 45. The processor 45 performs calculations to determine water losses based on the measured flow rate and the measured temperature. The processor controls the rate of make-up water flow into the regenerator by controlling either the speed of the make-up water pump 51 or, in other embodiments, by manipulating a make-up water flow control valve. A flow indicator 53 on line 55 provides an indication of make-up water flow rate to the processor through communication line 57, and may be used for feedback control of the pump speed or valve position to maintain a desired make-up water flow rate.

The water evaporate lost in the regenerator overheads controls the evaporative water losses in the AGR process, and thus the regenerator overhead temperature can be monitored to calculate the evaporative losses. Monitoring both the regenerator overhead temperature and the feed gas flow rate using a regenerator overhead temperature sensor and a feed gas flow rate sensor, respectively, allows for calculating of the evaporative losses and entrainment losses, and thus allows for maintaining the water balance in the AGR process. The amount of make-up water required to account for evaporative and entrainment losses has been found to be correlated to the train capacity (which is the feed gas flow rate) and regenerator overheads temperature (which is also called the acid gas temperature).

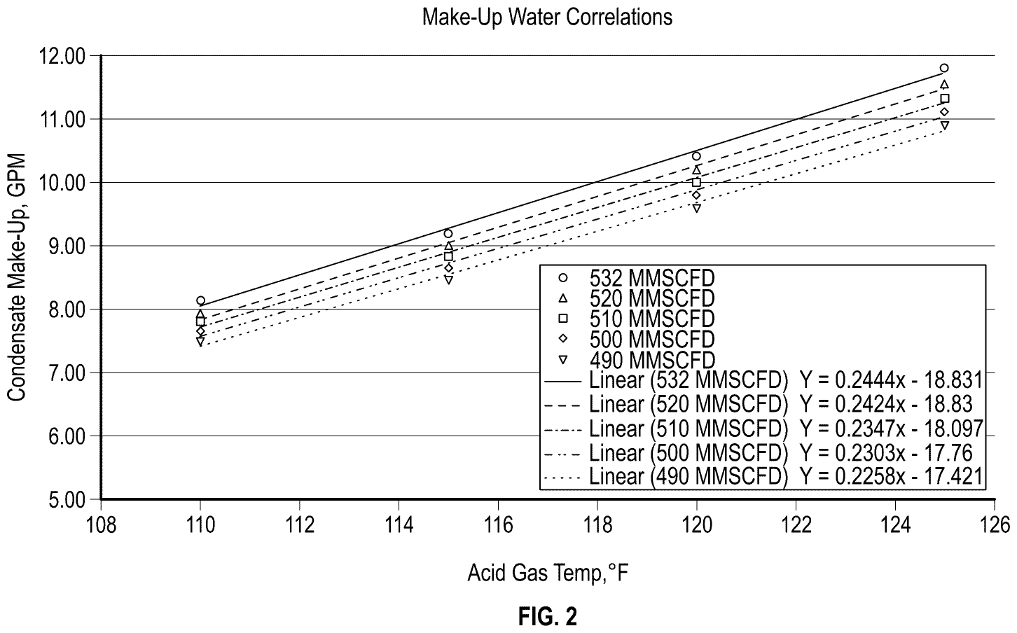

The correlation of the water losses may be provided, for example, by modeling a water capacity of the sweetened natural gas and a water capacity of the acid gas stream, such as by using PROMAX or other process simulation software. A series of make-up water correlations made using simulated data are shown in FIG. 2. PROMAX was used to model the AGR process for a particular plant. Using the simulation, the make-up water required was determined for a given train capacity at multiple acid gas temperatures and as a function of the flow rate measured of the sour natural gas, allowing for the determination of the set of correlation curves shown in FIG. 2. The simulation is repeated at multiple different constant sour gas feed rates to determine water losses as a function of regenerator overheads temperature for the multiple different sour gas feed rates.

This correlation allows for interpolating and determining the make-up water requirement when the train capacity and acid gas temperature are known, including when the train capacity is determined by monitoring a feed gas flow rate sensor and the acid gas temperature is determined by monitoring a regenerator overhead temperature sensor. These correlations take the form of the formula:

$$W = K * ( regenerator overhead temperature ) + I$$

where W is the make-up water flow rate requirement determined by simulation, K is the slope, and I is the intercept. Each feed gas flow rate exhibits a unique correlation, so by monitoring the feed gas flow rate and the regenerator overhead temperature, the make-up water flow rate requirement W may be determined.

While the correlation that may be appropriate for any particular unit may vary depending on ambient conditions, sour gas composition, sweetened gas composition, and other variables known in the art, simulations for an exemplary AGR system, provided the following correlations for determining the water make-up flow rate as a function of feed gas flow rate and regenerator overheads temperature.

TABLE 1
Correlation of water flow for various feed gas flow rates.

| Feed Gas Flow | | |
|---|---|---|
| Rate (MM SCFD) | K (slope) | I (intercept) |
| 490 | 0.2258 | −17.421 |
| 500 | 0.2303 | −17.76 |
| 510 | 0.2347 | −18.097 |
| 520 | 0.2424 | −18.83 |
| 532 | 0.2444 | −18.831 |

The processor may be configured to calculate the make-up water flow rate based on the above noted correlation for a given flow rate. Typically, the correlation equation would be pre-loaded into the processor based off previous simulations. For a flow rate intermediate those for the provided correlations, the processor may be configured to determine slope as a function of feed gas flow rate, intercept as a function of feed gas flow rate, and then to calculate the water make-up flow rate based on the determined slope and intercept.

In one or more embodiments, maintaining the amount of water circulating in the AGR process includes measuring the flow rate of the sour natural gas using a feed gas flow rate sensor (flow indicator 5 in FIG. 1), and measuring the temperature of the regenerator overheads by using a regenerator overhead temperature sensor (temperature indicator 35 in FIG. 2). These live (real-time) measurements can then be used to determine the proper make-up water flow rate as dictated by the correlations discussed above.

In one or more embodiments, the make-up water flow rate is automatically adjusted during the AGR process. In such embodiments, the feed gas flow rate sensor and regenerator overhead temperature sensor are in communication with a processor. The processor is also in communication with a make-up water flow control valve or a speed controller of a make-up water pump (pump 51 in FIG. 2), which allow the processor to adjust the make-up water flow rate, either by sending a signal to adjust the pump speed or a position of the make-up water flow control valve. The processor uses the correlations to determine a make-up water requirement based on inputs of the feed gas flow rate and regenerator overhead temperature. In one or more embodiments, the processor is configured to then automatically adjust the make-up water flow control valve position to match the required make-up water flow rate. During automatic control, these adjustments happen in response to changes in feed gas flow rate or regenerator overheads temperature. The processor may also be in communication with a screen or other graphical user interface (GUI) that can display the feed gas flow rate, regenerator overhead temperature, and make-up water flow rate.

In another aspect, embodiments disclosed herein relate to a process for AGR with a manually controlled AGR water balance aided by a user interface. This process is similar to the process of automatic control outlined above, except that the processor is not configured to then automatically adjust the make-up water flow control valve or pump speed to match the required make-up water flow rate. Instead, the processor is configured to display the feed gas flow rate, regenerator overhead temperature, and make-up water flow rate in an operator dashboard graphical user interface (GUI).

The operator dashboard GUI may be any applicable GUI capable of displaying feed gas flow rate of sour natural gas, regenerator overhead temperature, determined make-up water requirement, and make-up water flow rate, and take commands for adjusting make-up water flow rate. In such an embodiment, the processor is configured to determine and display the required make-up water flow rate from the simulated correlations. However, there is no automatic adjustment to the make-up water flow control valve, rather adjustments of the make-up water flow rate are made by the operator in the operator dashboard GUI. In such embodiments, the make-up water flow rate may be provided continuously, or make-up water may be added periodically, such as based on an accumulated estimate of water losses over a period of time.

Embodiments of the present disclosure may provide at least one of the following advantages. Automatic control of AGR water balance leads to a consistent amine (solvent) solution strength which helps to maintain steady and reliable gas train and acid gas removal operations. Automatic control of AGR water balance is predicted to have significant cost savings. Either process, AGR with an automated AGR water balance control or AGR with a manually controlled AGR water balance aided by a user interface, allows for operators to easily control AGR water balance and increase operation ease and efficiency.

Unless defined otherwise, all technical and scientific terms used have the same meaning as commonly understood by one of ordinary skill in the art to which these systems, apparatuses, methods, processes and compositions belong.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for acid gas removal, comprising:
feeding a sour natural gas to a contactor, wherein the sour natural gas comprises methane and one or more acid gases selected from carbon dioxide and hydrogen sulfide;
feeding a lean amine adsorbent to the contactor, wherein the lean amine adsorbent comprises water and a solvent;
in the contactor, contacting the sour natural gas with the lean amine adsorbent to produce a sweet natural gas, comprising methane and entrained water, and a rich amine absorbent, comprising water, solvent, and absorbed acid gases;
recovering the sweet natural gas as an overheads from the contactor;
recovering the rich amine absorbent as a bottoms from the contactor;
feeding the rich amine absorbent to a regenerator, recovering desorbed acid gases as a regenerator overheads and producing the lean amine adsorbent, recovered as a regenerator bottoms, wherein the regenerator overheads comprises water evaporate and desorbed acid gases comprising the one or more acid gases; and
maintaining an amount of water circulating, wherein maintaining an amount of water circulating comprises:
measuring a flow rate of the sour natural gas;
measuring a temperature of the regenerator overheads; and
adjusting a make-up water flow rate based on the flow rate measured of the sour natural gas and the temperature of the regenerator overheads measured.

2. The process of claim 1, wherein the solvent is selected from the group consisting of monoethanolamine (MEA), diglycolamine (DGA), diethanolamine (DEA), diisopropanolamine (DPA), and methyldiethanolamine (MDEA).

3. The process of claim 1, wherein make-up water is fed into the contactor via adjusting a position of a make-up water flow control valve or adjusting a speed of a make-up water feed pump.

4. The process of claim 1, wherein maintaining an amount of water circulating further comprises:
calculating a flow rate of the entrained water based on the flow rate measured of the sour natural gas; and
calculating a flow rate of the water evaporate based on the temperature of the regenerator overheads measured.

5. The process of claim 1, wherein maintaining an amount of water circulating further comprises:
with a processor, automatically,
determining a slope K and an intercept I as a function of the flow rate measured of the sour natural gas;
calculating a make-up water flow rate W based on a formula:
W=K*(regenerator overhead temperature)+I; and
wherein the processor automatically adjusts make-up water flow rate based on the make-up water flow rate W calculated.

6. The process of claim 1 wherein maintaining an amount of water circulating further comprises:
through a user interface,
inputting the flow rate of the sour natural gas and the temperature of the regenerator overheads into a processor, the processor:
determining a slope K and an intercept I as a function of the flow rate measured of the sour natural gas;
calculating a make-up water flow rate W based on a formula:
$$W = K * ( regenerator overhead temperature ) + I ;$$
and
displaying the flow rate of the sour natural gas, the temperature of the regenerator overheads, and the make-up water flow rate W;
wherein adjusting the make-up water flow rate further comprises setting the make-up water flow rate based on the make-up water flow rate W displayed.

7. The process of claim 5, further comprising:
simulating, at a constant sour gas feed rate, water losses from the contactor and the regenerator at multiple regenerator overheads temperatures to determine water losses as a function of regenerator overheads temperature for the constant sour gas feed rate;
repeating the simulating at multiple different constant sour gas feed rates to determine water losses as a function of regenerator overheads temperature for the multiple different sour gas feed rates;
determining slope K and intercept I for each of the constant sour gas feed rates; and
based on the determined slopes K and intercepts I, deriving an equation to calculate K as a function of sour gas feed rate and deriving an equation to calculate I as a function of sour gas feed rate.

8. The process of claim 7, further comprising inputting the equation to calculate K and the equation to calculate I into the processor.

9. The process of claim 6, further comprising:
simulating, at a constant sour gas feed rate, water losses from the contactor and the regenerator at multiple regenerator overheads temperatures to determine water losses as a function of regenerator overheads temperature for the constant sour gas feed rate;
repeating the simulating at multiple different constant sour gas feed rates to determine water losses as a function of regenerator overheads temperature for the multiple different sour gas feed rates;
determining slope K and intercept I for each of the constant sour gas feed rates; and
based on the determined slopes K and intercepts I, deriving an equation to calculate K as a function of sour gas feed rate and deriving an equation to calculate I as a function of sour gas feed rate.

10. The process of claim 9, further comprising inputting the equation to calculate K and the equation to calculate I into the processor.

11. A system for carrying out the process of claim 1, the system comprising:
a contactor comprising sour natural gas and lean amine adsorbent feed lines, the contactor having a contactor overheads recovery line to recover sweet natural gas and a contactor bottoms recovery line to recover the rich amine absorbent;
wherein the contactor bottoms recovery line feeds rich amine absorbent directly or indirectly to a regenerator;
the regenerator, comprising a regenerator overheads recovery line which recovers desorbed acid gases and a regenerator bottoms recovery line which recovers lean amine adsorbent for conveyance to the contactor;
a regenerator overhead temperature sensor;
a feed gas flow rate sensor;
a make-up water feed system;
wherein the regenerator overhead temperature sensor, feed gas flow rate sensor, and make-up water flow control system are in communication with a processor; and
wherein the processor is configured to automatically calculate a required make-up water flow rate and to send a signal to adjust a position of a make-up water flow control valve.
